(19) United States
(12) Patent Application Publication
(10) Pub. No.: US 2014/0287234 A1
(43) Pub. Date: Sep. 25, 2014

(54) FLUORESCENT SUBSTANCE AND METHOD FOR PRODUCING THE SAME

(71) Applicant: KABUSHIKI KAISHA TOSHIBA, Minato-ku (JP)

(72) Inventors: Aoi OKADA, Kawasaki-Shi (JP); Masahiro KATO, Naka-Gun (JP); Kunio ISHIDA, Tokyo (JP); Keiko ALBESSARD, Yokohama-Shi (JP); Yumi FUKUDA, Tokyo (JP); Iwao MITSUISHI, Tokyo (JP)

(73) Assignee: KABUSHIKI KAISHA TOSHIBA, Minato-ku (JP)

(21) Appl. No.: 14/183,743

(22) Filed: Feb. 19, 2014

(30) Foreign Application Priority Data
Mar. 22, 2013 (JP) 2013-060588

(51) Int. Cl. C09K 11/77; B02C 19/06

(52) U.S. Cl. CPC C09K 11/7715; B02C 19/06
USPC 428/402; 252/301.4 F; 241/30; 241/5

(57) ABSTRACT

The present embodiments provide a yellow light-emitting fluorescent substance of high luminous efficiency and also a production method thereof. This substance is represented by the formula (1):

(M₁₋ₓREₓ)_{2y}Al_{z}Si_{10-z}OᵤN_{w} (1)

(in the formula, M is at least one element selected from the group consisting of Ba, Sr, Ca, Mg, Li, Na and K), and emits luminescence with a peak within 500 to 600 nm when excited by light of 250 to 500 nm. In the emission spectrum of the substance, the emission band with the above peak has a half-width corresponding to an energy difference of 0.457 eV or less. The substance can be obtained by pulverizing a material mixture so that the D90 value may be 5 μm or less and then by firing the pulverized mixture.

### CROSS-REFERENCE TO RELATED APPLICATIONS

This application is based upon and claims the benefit of priority from the Japanese Patent Application No. 2013-060588, filed on Mar. 22, 2013, the entire contents of which are incorporated herein by reference.

### FIELD

Embodiments of the present disclosure relate to a fluorescent substance usable for light-emitting devices and also to a method for producing that substance.

### BACKGROUND

A blue LED and a yellow light-emitting fluorescent substance Y₃Al₅O₁₂:Ce³⁺ (YAG) were combined to develop a white LED, and since then various studies have been made on the applications thereof for lighting instruments, backlight sources of liquid crystal displays and the like. Recently, white LEDs have been improved to increase brightness, and the chips thereof have been used at higher temperatures. In accordance with that, it has been desired to further develop a fluorescent substance excellent in both brightness and temperature characteristics.

### BRIEF DESCRIPTION OF THE DRAWINGS

FIG. 1 shows a vertical sectional view schematically illustrating a light-emitting device according to an embodiment.

FIG. 2 shows an emission spectrum of the fluorescent substance obtained in Example 1.

FIG. 3 shows an emission spectrum of the fluorescent substance obtained in Example 1.

FIG. 4 shows an emission spectrum of the fluorescent substance obtained in Example 2.

substance obtained in Example 2.

FIG. 5 shows an emission spectrum of the fluorescent substance obtained in Example 2.

FIG. 6 shows an emission spectrum of the fluorescent substance obtained in Example 3.

FIG. 7 shows an emission spectrum of the fluorescent substance obtained in Example 3.

FIG. 8 shows an emission spectrum of the fluorescent substance obtained in Example 4.

FIG. 9 shows an emission spectrum of the fluorescent substance obtained in Example 4.

FIG. 10 shows an emission spectrum of the fluorescent substance obtained in Example 5.

FIG. 11 shows an emission spectrum of the fluorescent substance obtained in Example 5.

FIG. 12 shows an emission spectrum of the fluorescent substance obtained in Example 6.

FIG. 13 shows an emission spectrum of the fluorescent substance obtained in Example 6.

FIG. 14 shows an emission spectrum of the fluorescent substance obtained in Example 7.

FIG. 15 shows an emission spectrum of the fluorescent substance obtained in Example 7.

FIG. 16 shows an emission spectrum of the fluorescent substance obtained in Comparative example 1.

FIG. 17 shows an emission spectrum of the fluorescent substance obtained in Comparative example 2.

FIG. 18 shows an emission spectrum of the fluorescent substance obtained in Comparative example 3.

FIG. 19 shows an emission spectrum of the fluorescent substance obtained in Comparative example 4.

FIG. 20 shows an emission spectrum of the fluorescent substance obtained in Comparative example 5.

FIG. 21 shows an emission spectrum of the fluorescent substance obtained in Comparative example 6.

FIG. 22 shows an emission spectrum of the fluorescent substance obtained in Comparative example 7.

FIG. 23 shows a particle size distribution curve of the material mixture in Example 1.

FIG. 24 shows a particle size distribution curve of the material mixture in Example 2.

FIG. 25 shows a particle size distribution curve of the material mixture in Example 3.

FIG. 26 shows a particle size distribution curve of the material mixture in Example 4.

FIG. 27 shows a particle size distribution curve of the material mixture in Example 5.

FIG. 28 shows a particle size distribution curve of the material mixture in Example 6.

FIG. 29 shows a particle size distribution curve of the material mixture in Example 7.

FIG. 30 shows a particle size distribution curve of the material mixture in Comparative example 1.

FIG. 31 shows a particle size distribution curve of the material mixture in Comparative example 2.

FIG. 32 shows a particle size distribution curve of the material mixture in Comparative example 3.

FIG. 33 shows a particle size distribution curve of the material mixture in Comparative example 4.

FIG. 34 shows a particle size distribution curve of the material mixture in Comparative example 5.

FIG. 35 shows a particle size distribution curve of the material mixture in Comparative example 6.

FIG. 36 shows a particle size distribution curve of the material mixture in Comparative example 7.

### DETAILED DESCRIPTION

Embodiments will now be explained with reference to the accompanying drawings.

### Yellow Light-Emitting Fluorescent Substance

A fluorescent substance according to the embodiment represented by the following formula (1):

(M₁₋ₓREₓ)_{2y}Al_{z}Si_{10-z}OᵤN_{w} (1)

in which

M is at least one element selected from the group consisting of Ba, Sr, Ca, Mg, Li, Na and K;

RE is an element selected from the group consisting of Ce, Tb, Eu and Mn; and

x, y, z, u and w are numbers satisfying the conditions of

0<x≦1,

0.8≦y≦1.1,

2.4≦z≦3.5,

0<u≦1,

1.8≦z−u and

13≦u+w≦15, respectively,

wherein said fluorescent substance emitting luminescence with a peak in the wavelength range of 500 to 600 nm under excitation by light in the wavelength range of 250 to 500 nm, and showing an emission spectrum in which emission band with said peak has a half-width corresponding to an energy difference of 0.457 eV or less.

The yellow light-emitting fluorescent substance is characterized by having a particular composition, by emitting luminescence with a peak in the wavelength range of 500 to 600 nm under excitation by light in the wavelength range of 250 to 500 nm, and by showing an emission spectrum having a half-width of 0.457 eV or less.

First, the following explains the half-width of the emission spectrum in the embodiment of the present disclosure. An emission spectrum obtained by spectroscopic analysis generally indicates a relation between the emission intensity and wavelength (nm). If the wavelength (nm) on the horizontal axis is converted into energy (eV) according to the later-described conversion formula between the wavelength and energy, the spectrum can be converted into a relation between the emission intensity and energy. In the embodiment of the present disclosure, the half-width of the emission spectrum means an energy difference between the higher and lower energy points at which the emission intensity is equal to half of the peak intensity in the converted spectrum.

When electrons undergo transition from an excited state to the ground state in the fluorescent substance according to the embodiment of the present disclosure, an energy difference between the states is released in the form of light and is observed as luminescence. Accordingly, in study of the luminescence, it is often convenient to calibrate the horizontal axis in terms of not wavelength but energy.

The prior art has not provided the fluorescent substance showing an emission spectrum of small half-width. Detailed explanation of that fluorescent substance will be described below.

The fluorescent substance according to the embodiment of the present disclosure is represented by the following formula (1):

(M₁₋ₓREₓ)_{2y}Al_{z}Si_{10-z}OᵤN_{w} (1)

in which

M is at least one element selected from the group consisting of Ba, Sr, Ca, Mg, Li, Na and K;

RE is an element selected from the group consisting of Ce, Tb, Eu and Mn; and

x, y, z, u and w are numbers satisfying the conditions of

0<x≦1,

0.8≦y≦1.1,

2.4≦z≦3.5,

0<u≦1,

1.8≦z−u and

13≦u+w≦15, respectively; and is generally categorized into a kind of SiAION phosphor. This fluorescent substance emits luminescence with a peak in the wavelength range of 500 to 600 nm when excited by light in the wavelength range of 250 to 500 nm, and hence is a yellow light-emitting phosphor. The basic crystal structure of the fluorescent substance is essentially the same as (Sr,Ce)₂Si₇Al₃ON₁₃.

The fluorescent substance according to the embodiment of the present disclosure is thus characterized by having a particular composition, by emitting luminescence with a peak in the wavelength range of 500 to 600 nm under excitation by light in the wavelength range of 250 to 500 nm, and by showing an emission spectrum having a half-width of 0.457 eV or less.

The wavelength in the emission spectrum can be converted into energy according to the following relation between the wavelength and energy of light:

$$\begin{matrix}E = hv [ J ] \\ = h \frac{c}{λ} [ J ] \\ = h \frac{c}{e λ} [ eV ]\end{matrix}$$

in which

E: energy,

h: planck constant h=6.626×10⁻³⁴ [J·s],

c: speed of light c=2.998×10⁸ [m/s],

v: frequency,

λ: wavelength (nm), and

e: elementary charge e=1.602×10⁻¹⁹ [C].

The above relation indicates that the energy E (eV) is almost equal to 1240/λ[wavelength (nm)].

Accordingly, the energy difference of 0.457 eV corresponds to a half-width of 118 nm in the emission spectrum having a peak in the wavelength range of 500 to 600 nm. The emission spectrum having a narrow half-width suggests that the emission center ions are evenly coordinated and hence that the fluorescent substance is uniformly formed. As described later, the uniform fluorescent substance can be produced by use of a method in which a mixture of materials is so controlled as to be highly homogeneous. By increasing the homogeneity of the mixture, the half-width of the emission spectrum can be further reduced to 0.450 eV or less.

If the half-width is narrowed in the emission spectrum, the luminous efficiency is simultaneously improved to enhance the luminescence. As a result, the fluorescent substance showing that emission spectrum enables to produce a light-emitting device excellent in brightness.

In the formula (1), M is at least one element selected from the group consisting of Ba, Sr, Ca, Mg, Li, Na and K. Among them, Sr is most preferred. The metal element M may be a single element, but two or more elements can be used in combination as the metal element M. An M-containing compound used as one of the materials is preferably nitride or carbide. In the case where the metal element M is Sr, the nitride Sr₃N₂ is often supplied in the form of large particles. Specifically, the Sr₃N₂ particles often have a mean diameter of several tens of micro-meters. If the materials include those large particles, the resultant phosphor is liable to have low luminous efficiency.

The metal element RE functions as an emission center of the fluorescent substance. Specifically, the fluorescent substance according to the embodiment has a crystal structure basically comprising the elements M, Al, Si, O and N, but the element M is partly replaced with the emission center element RE. The element RE is selected from the group consisting of Ce, Tb, Eu, and Mn. Two or more of them can be used in combination. Among them, Ce is most preferred because it enables to produce a yellow light-emitting phosphor excellent in luminescent properties.

The fluorescent substance according to the embodiment further contains Al and Si, which may be partly replaced with analogous elements as long as they impair the effect of the present embodiment. Specifically, Si may be partly replaced with Ge, Sn, Ti, Zr or Hf, and Al may be partly replaced with B, Ga, In, Sc, Y, La, Gd or Lu.

Further, the fluorescent substance according to the embodiment has specific composition ratios. In the formula (1), the ratios represented by x, y, z, u and w need to satisfy the following particular conditions: that is,

0<x≦1, preferably 0.001≦x≦0.5;

0.8≦y≦1.1, preferably 0.85≦y≦1.06;

2.4≦z≦3.5, preferably 2.5≦z≦3.3;

0<u≦1, preferably 0.001≦u≦0.8;

1.8≦z−u, preferably 2.0≦z−u; and

13≦u+w≦15, preferably 13.2≦u+w≦14.2; respectively.

The fluorescent substance can emit luminescence if the metal element M is at least partly replaced with the emission center element RE. However, if 0.1 mol % or more of the metal element M is replaced with the element RE (that is, if x is 0.001 or more), the fluorescent substance can have sufficient luminous efficiency. The metal element M may be completely replaced with RE (that is, x may be 1), but the replacement ratio with RE is preferably 50 mol % or less (that is, x is preferably 0.5 or less) so as to avoid decrease of the emission probability (that kind of decrease is often referred to as “concentration quenching”). Accordingly, the number x satisfies the condition of 0<x≦1, preferably 0.001≦x≦0.5.

The number y is 0.8 or more, preferably 0.85 or more, so as to avoid formation of crystal defects and to prevent decrease of the efficiency. On the other hand, however, the number y is 1.1 or less, preferably 1.06 or less so that excess of the alkaline earth metal may not deposit in the form of a variant phase to decrease the luminous efficiency. Accordingly, the number y satisfies the condition of 0.8≦x≦1.1, preferably 0.85≦x≦1.06.

The number z is 2.4 or more, preferably 2.5 or more so that excess Si may not deposit in the form of a variant phase to decrease the luminous efficiency. On the other hand, however, if it is more than 3.5, excess Al may deposit in the form of a variant phase to decrease the luminous efficiency. The number z is hence 3.5 or less, preferably 3.3 or less. Accordingly, the number z satisfies the condition of 2.4≦z≦3.5, preferably 2.5≦z≦3.3 preferably.

The number u is 1 or less, preferably 0.8 or less so that crystal defects may not increase to lower the luminous efficiency. On the other hand, however, it is preferably 0.001 or more so as to maintain the desired crystal structure and to keep properly the wavelength of the emission spectrum. Accordingly, the number u satisfies the condition of o<u≦1, preferably 0.001≦u≦0.8.

The value of z−u is 1.8 or more, preferably 2.0 or more so that the fluorescent substance of the embodiment can retain the desired crystal structure and also so that variant phases may not be formed in the production process of the fluorescent substance. For the same reasons, the value of u+w satisfies the condition of 13≦u+w≦15, preferably 13.2≦u+w≦14.2.

### Method for Producing the Fluorescent Substance

According to the embodiment of the present disclosure, a method for producing the fluorescent substance is partly characterized by controlling the particle sizes of the material mixture, but it is not necessary to prepare particular apparatuses or to perform special operations and hence the production cost is not increased. The following explains the method for producing the fluorescent substance according to the embodiment of the present disclosure.

The fluorescent substance according to the embodiment of the present disclosure can be synthesized from starting materials, such as, nitride or carbide of the element M; nitride, oxide or carbide of Al and Si; and chloride, oxide, nitride or carbonate of the emission center element RE. For example, in the case where a phosphor containing Sr and Ce as the elements M and RE, respectively, is intended to be produced, Sr₃N₂, AlN, Si₃N₄ and CeCl₃ can be used as the starting materials. The material Sr₃N₂ may be replaced with Ca₃N₂, Ba₃N₂, Sr₂N, SrN or the like or a mixture thereof. Those materials are so weighed out and mixed that the desired composition can be obtained, and then the mixture is fired to produce the aimed fluorescent substance. However, before the firing procedure, it is necessary to control the particle size distribution of the material mixture.

The particle size distribution of the material mixture can be controlled in any manner. For example, the materials are mixed and then the mixture is pulverized to control the particle size distribution, or otherwise the materials may be beforehand individually pulverized to control the particle sizes and then mixed. However, in view of the simplicity of the procedure, it is preferred to control the particle size distribution after the materials are mixed.

Any conventionally known technique can be used to pulverize the materials. For example, the materials may be mixed in a mortar or may be pulverized by means of a mill, such as, a ball mill, a tube mill, an impact mill, or a roll mill. However, in the embodiment of the present disclosure, it is preferred to use a jet mill so as to readily control the particle sizes. In the jet mill, a highly compressed gas is jetted from a nozzle at about sonic speed and made to impact the material particles so that the particles may crash with each other. The jet mill has the advantages that very fine pulverized particles can be obtained, that the temperature of the particles hardly rises in the course of pulverizing them and that the particles are hardly contaminated with impurities because they are pulverized by collisions among themselves. As the jet mill, for example, a jet milling machine “Nano Jetmizer” ([trademark], manufactured by Aisin Nano Technologies CO., LTD.) can be used.

In the embodiment of the present disclosure, the pulverized material mixture needs to have a particle size distribution in which the D90 value is 5 μm or less. Here, the “D90 value” means a particle size corresponding to a cumulative value of 90% accumulated from the small diameter side in the cumulative distribution curve. In the present embodiment, the D90 value is preferably 5 μm or less, more preferably 2.5 μm or less. The D100 value is also preferably small. Specifically, the D100 value is preferably 6 μm or less. The particle size distribution can be measured in various manners. Specifically, for example, the material mixture is added in isopropyl alcohol, and subjected to supersonic dispersing in a supersonic bath for about 15 seconds. Thereafter, the particle size distribution can be then measured by means of CILAS 1046L laser scattering-diffraction particle size distribution analyzer ([trademark], manufactured by Aisin Nano Technologies CO., LTD.), with which the particle sizes can be measured in the range of 0.04 to 500 μm.

Also in conventional processes for producing fluorescent substances, materials are often pulverized and mixed before fired. However, the prior art is silent about the relation between the particle size distribution of the pulverized materials and the luminescent properties of the resultant phosphor, and this relation has been first found by the present applicant. Further, it has been also found that the relation between the size distribution and the luminescent properties is strongly observed in SiAlON phosphors. That is presumed to be because a SiAlON phosphor has a crystal structure in which silicon and aluminum atoms are so complicatedly positioned that the uniformity of the phosphor very depends on the size distribution of the material mixture and accordingly that the luminescent properties are readily affected by the size distribution. Because of that, in producing the fluorescent substance having a particular composition specified in the embodiment of the present disclosure, excellent luminescent properties can be achieved by controlling the particle size distribution of the material mixture.

Subsequently, the material mixture whose particle sizes are controlled is then fired for predetermined time. The mixture is preferably fired under a pressure not less than the atmospheric pressure. If silicon nitride is used as one of the materials, the pressure is further preferably 5 atm or more so as to prevent the silicon nitride from decomposing at a high temperature. The firing temperature is preferably 1500 to 2000° C., more preferably 1800 to 2000° C. If the temperature is lower than 1500° C., it is often difficult to produce the aimed fluorescent substance. On the other hand, if it is higher than 2000° C., it is feared that the materials or product may sublimate. Further, if the materials contain nitrides, it is preferred to fire them in a N₂ atmosphere because they tend to be oxidized. However, they may be fired in a N₂/H₂ mixed atmosphere. As described above, the oxygen content in the atmosphere should be strictly controlled.

After the firing procedure, the obtained powder is subjected to after-treatments such as washing, if necessary, to obtain a fluorescent substance of the present embodiment.

The washing can be carried out, for example, by use of pure water or acid.

### Light-Emitting Device

The fluorescent substance according to the embodiment of the present disclosure can be combined with a light-emitting element capable of exciting it, to produce a light-emitting device.

The light-emitting device according to the embodiment of the present disclosure comprises a combination of a light-emitting element serving as an excitation light source and the above yellow-light emitting fluorescent substance (Y), which emits luminescence under excitation by light radiated from the light-emitting element. Consequently, the light-emitting device gives off light synthesized from the excitation light radiated from the light-emitting element and the luminescence emitted from the yellow-light emitting fluorescent substance.

The light-emitting element, such as a LED element, is properly selected in view of the combination with the used fluorescent substance. Specifically, the light-emitting element needs to radiate light capable of exciting the used fluorescent substance. Further, in the case where it is preferred for the devise to give off white light, the light-emitting element preferably radiates light of wavelength complementary to the luminescence emitted from the fluorescent substance.

In consideration of the above, in producing the light-emitting device comprising a yellow-light emitting phosphor as the fluorescent substance, the light-emitting element is so selected as to radiate light in the wavelength range of 250 to 500 nm.

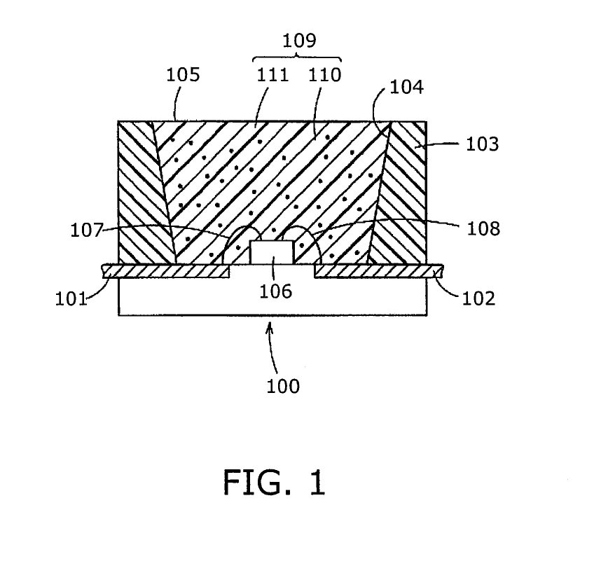

The light-emitting device according to the embodiment of the present disclosure can be in any form of known devices. FIG. 1 shows a vertical sectional view schematically illustrating a light-emitting device according to an embodiment of the present disclosure.

The light-emitting device 100 shown in FIG. 1 comprises leads 101 and 102, which are formed as a part of a lead frame, and also comprises a resin member 103, which is formed by integral molding with the lead frame. The resin member 103 has a concavity 105 in which the top opening is larger than the bottom. The inside wall of the concavity 105 is coated with a reflective surface 104.

At the center of the nearly circular bottom of the concavity 105, there is a light-emitting element 106 mounted with Ag paste or the like. Examples of the light-emitting element 106 include light-emitting diodes and laser diodes, such as a GaN type semiconductor light-emitting element. The light-emitting element is so selected as to radiate light of proper wavelength according to the combination with the fluorescent substance. The electrodes (not shown) of the light-emitting element 106 are connected to the leads 101 and 102 by way of bonding wires 107 and 108 made of Au or the like, respectively. The positions of the leads 101 and 102 can be adequately modified.

In the luminescent layer 109, the fluorescent substance according to the embodiment of the present disclosure is dispersed or precipitated in a resin layer 111 made of, for example, silicone resin in an amount of 5 to 50 wt %. The fluorescent substance according to the embodiment comprises an oxynitride matrix having high covalency, and hence is generally hydrophobic enough to have very good compatibility with the resin. Accordingly, scattering at the interface between the resin and the fluorescent substance is prevented sufficiently to improve the light-extraction efficiency.

The light-emitting element 106 may be of a flip chip type in which the n- and p-electrodes are placed on the same plane. This element can avoid troubles concerning the wires, such as disconnection or dislocation of the wires and light-absorption by the wires. Accordingly, that element enables to obtain a semiconductor light-emitting device excellent both in reliability and in luminance. Further, it is also possible to use a light-emitting element 106 having an n-type substrate so as to produce a light-emitting device constituted as described below. Specifically, in that device, an n-electrode is formed on the back surface of the n-type substrate while a p-electrode is formed on the top surface of a semiconductor layer on the substrate. The n- or p-electrode is mounted on one of the leads, and the p- or n-electrode is connected to the other lead by way of a wire. The size and kind of the light-emitting element 106 and the dimension and shape of the concavity 105 can be properly changed.

The light-emitting device according to the embodiment of the present disclosure is not restricted to the package cup-type shown in FIG. 1, and can be freely modified. For example, even if the fluorescent substance of the embodiment is used in a shell-type or surface-mount type light-emitting device, the same effect can be obtained.

Embodiments of the present disclosure are further explained in detail by use of the following examples, but they by no means restrict the embodiments.

### EXAMPLES 1 TO 7

As the starting materials, Sr₃N₂, CeCl₃, Si₃N₄ and AlN were prepared. They were weighed out and mixed in a vacuum glove box, and then the mixture was pulverized with a jet mill in the vacuum glove box to obtain a material mixture. The blended amounts in each example were shown in Table 1.

The pulverizing conditions were as follows:
apparatus: Nano Jetmizer ([trademark], manufactured by Aisin Nano Technologies CO., LTD.),
grinding gas: nitrogen,
supply volume: 1 g/minute,
mill pressure: 0.75 MPa, and
pushing pressure: 1.85 MPa.

Subsequently, the particle size distribution of the pulverized mixture was measured by means of a laser scattering-diffraction particle size distribution analyzer to determine values of D10, D50, D90 and D100.

Each material mixture pulverized under the above conditions was laid in a BN crucible and then fired at 1800° C. for 15 hours under 7.5 atm in a N₂ atmosphere, to obtain a yellow-light emitting fluorescent substance. The obtained substance was subjected to composition analysis by ICP spectroscopy. The results were as set forth in Table 1.

### COMPARATIVE EXAMPLES 1 TO 7

As the starting materials, Sr₃N₂, CeCl₃, Si₃N₄ and AlN were prepared. They were weighed out in a vacuum glove box, and mixed not with a jet mill but manually with an agate mortar and pestle. The blended amounts in each example were shown in Table 1. Subsequently, the particle size distribution of the mixture was measured by means of a laser scattering-diffraction particle size distribution analyzer to determine values of D10, D50, D90 and D100.

Each material mixture pulverized under the above conditions was laid in a BN crucible and then fired at 1800° C. for the time shown in Table 1 under 7.5 atm in a N₂ atmosphere, to obtain a yellow-light emitting fluorescent substance.

TABLE 1

| | | | | | | Firing | |
|---|---|---|---|---|---|---|---|
| | | | | | | time | |
| | Blended composition | Sr₃N₂ | CeCl₃ | Si₃N₄ | AlN | (hr) | Result of composition analysis by ICP |
| Ex. 1 | (Sr_{0.98}Ce_{0.02})₂Si_{7.5}Al_{2.5}N₁₄ | 2.90 | 0.15 | 5.26 | 1.54 | 15 | (Sr_{0.93}Ce_{0.019})₂Si_{7.32}Al_{2.68}O_{0.61}N_{13.0} |
| Ex. 2 | (Sr_{0.975}Ce_{0.025})₂Si_{7.5}Al_{2.5}N₁₄ | 2.89 | 0.18 | 5.26 | 1.54 | 15 | (Sr_{0.91}Ce_{0.0245})₂Si_{7.58}Al_{2.42}O_{0.36}N_{13.3} |
| Ex. 3 | (Sr_{0.97}Ce_{0.03})₂Si_{7.5}Al_{2.5}N₁₄ | 2.87 | 0.22 | 5.26 | 1.54 | 15 | (Sr_{0.91}Ce_{0.0295})₂Si_{7.50}Al_{2.50}O_{0.41}N_{13.3} |
| Ex. 4 | (Sr_{0.975}Ce_{0.025})₂Si_{7.7}Al_{2.3}N₁₄ | 2.89 | 0.18 | 5.40 | 1.41 | 15 | (Sr_{0.915}Ce_{0.024})₂Si_{7.50}Al_{2.50}O_{0.36}N_{13.3} |
| Ex. 5 | (Sr_{0.975}Ce_{0.025})₂Si_{7.7}Al_{2.3}N₁₄ | 3.14 | 0.18 | 5.40 | 1.41 | 15 | (Sr_{0.955}Ce_{0.0245})₂Si_{7.49}Al_{2.51}O_{0.44}N_{13.5} |
| Ex. 6 | (Sr_{0.98}Ce_{0.02})₂Si_{7.5}Al_{2.5}N₁₄ | 2.90 | 0.15 | 5.26 | 1.54 | 15 | (Sr_{0.935}Ce_{0.02})₂Si_{7.34}Al_{2.55}O_{0.44}N_{13.4} |
| Ex. 7 | (Sr_{0.975}Ce_{0.025})₂Si_{7.7}Al_{2.3}N₁₄ | 2.89 | 0.18 | 5.40 | 1.41 | 15 | (Sr_{0.915}Ce_{0.025})₂Si_{7.62}Al_{2.47}O_{0.35}N_{13.4} |
| Com. Ex. 1 | (Sr_{0.98}Ce_{0.02})_{1.9}Si_{7.25}Al_{2.75}N₁₄ | 2.61 | 0.13 | 5.09 | 1.69 | 4 | |
| Com. Ex. 2 | (Sr_{0.98}Ce_{0.02})_{1.9}Si_{7.25}Al_{2.75}N₁₄ | 2.61 | 0.13 | 5.09 | 1.69 | 5 | |
| Com. Ex. 3 | (Sr_{0.98}Ce_{0.02})_{1.9}Si_{7.25}Al_{2.75}N₁₄ | 2.61 | 0.13 | 5.09 | 1.69 | 6 | |
| Com. Ex. 4 | (Sr_{0.97}Ce_{0.03})_{1.9}Si₇Al₃ON₁₄ | 2.59 | 0.20 | 4.91 | 1.84 | 4 | |
| Com. Ex. 5 | (Sr_{0.97}Ce_{0.03})_{1.9}Si₇Al₃ON₁₄ | 2.59 | 0.20 | 4.91 | 1.84 | 8 | |
| Com. Ex. 6 | (Sr_{0.97}Ce_{0.03})_{1.9}Si₇Al₃ON₁₄ | 2.59 | 0.20 | 4.91 | 1.84 | 9 | |
| Com. Ex. 7 | (Sr_{0.99}Ce_{0.01})_{1.9}Si_{7.25}Al_{2.75}N₁₄ | 2.64 | 0.07 | 5.09 | 1.69 | 3 | |

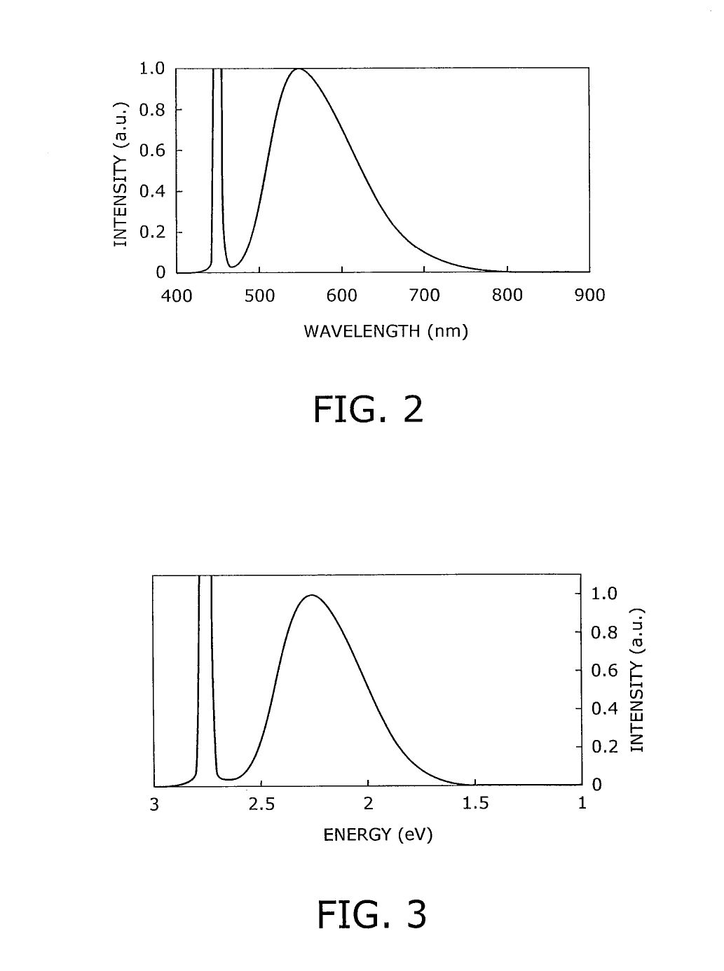

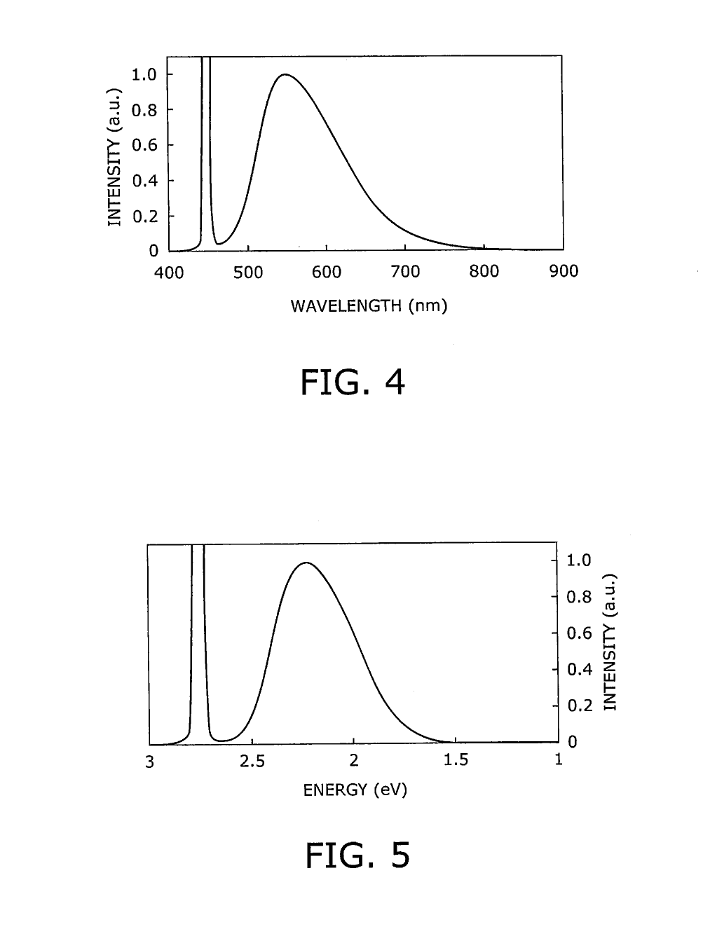

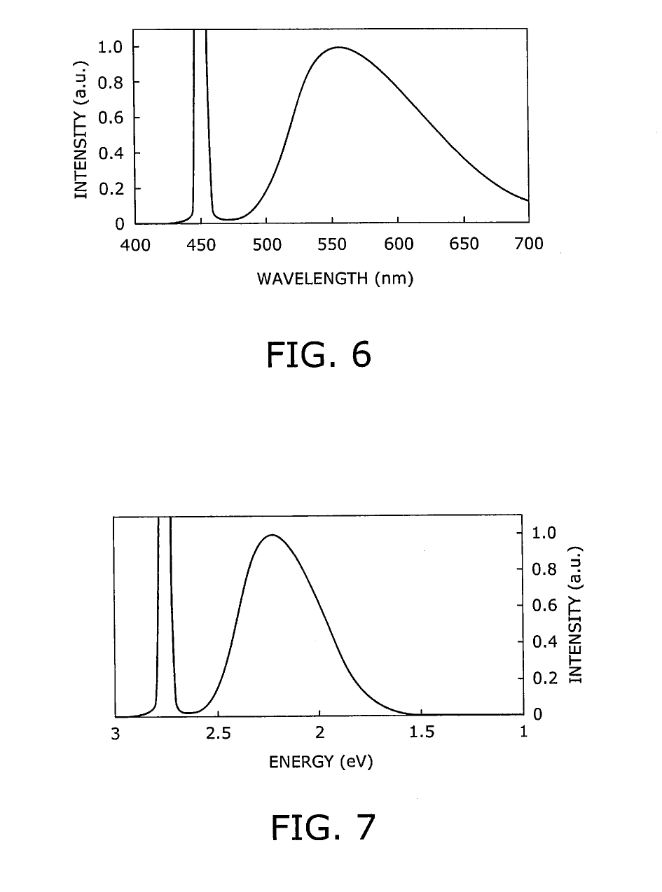

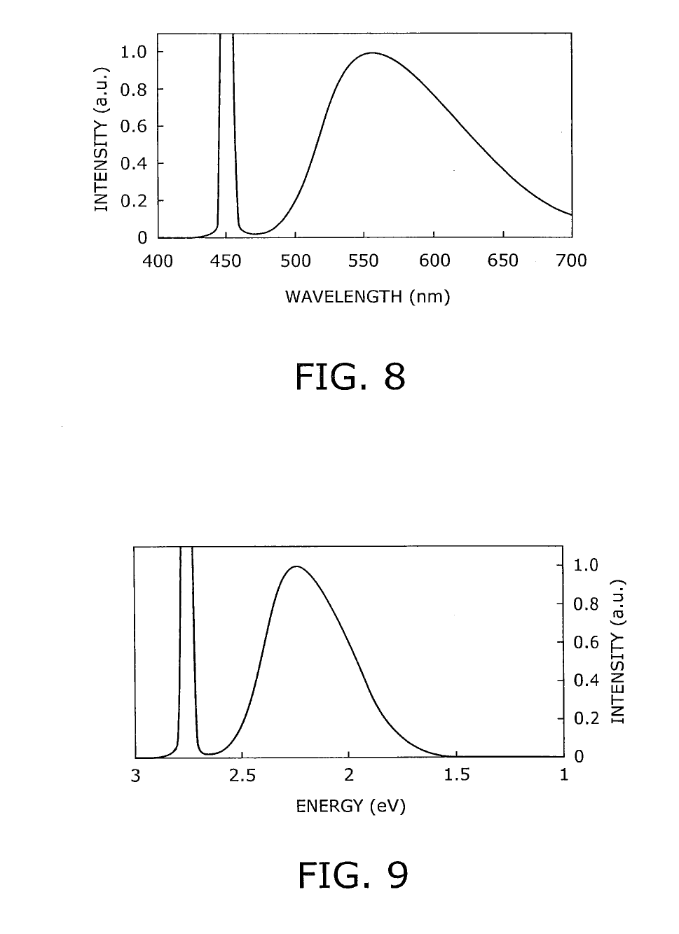

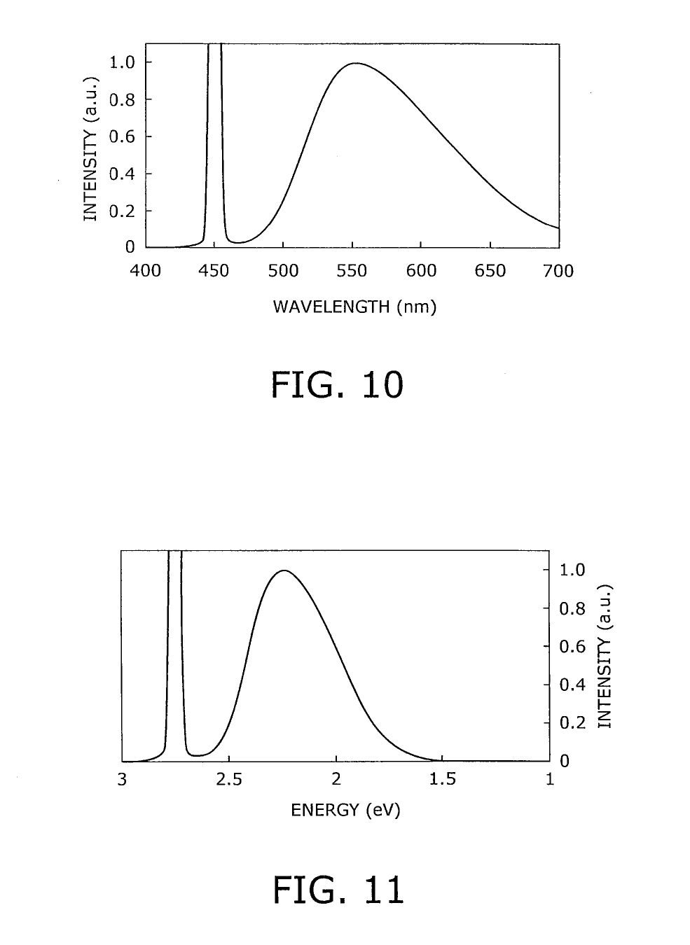

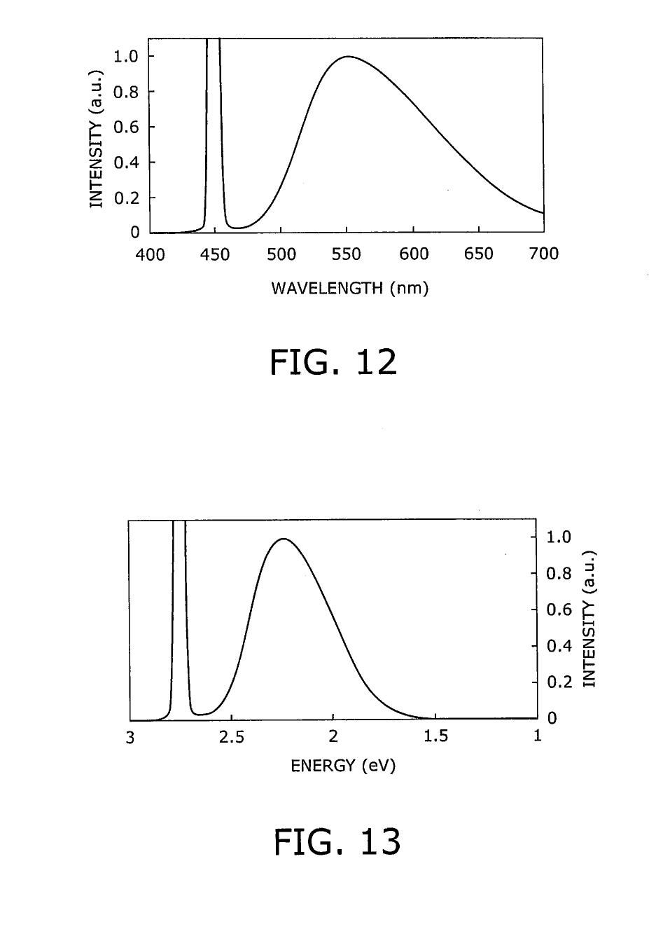

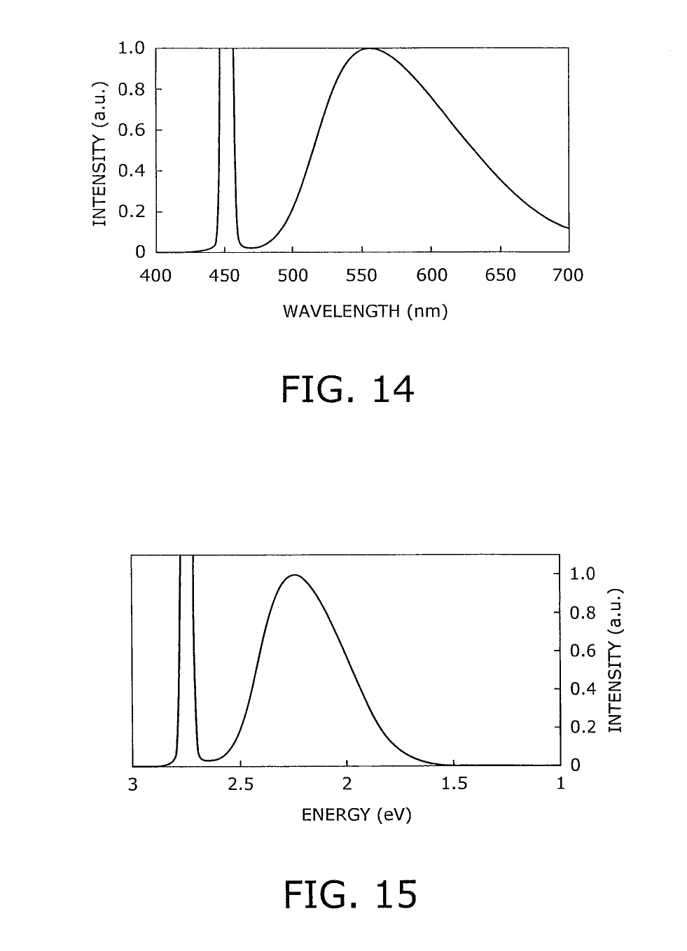

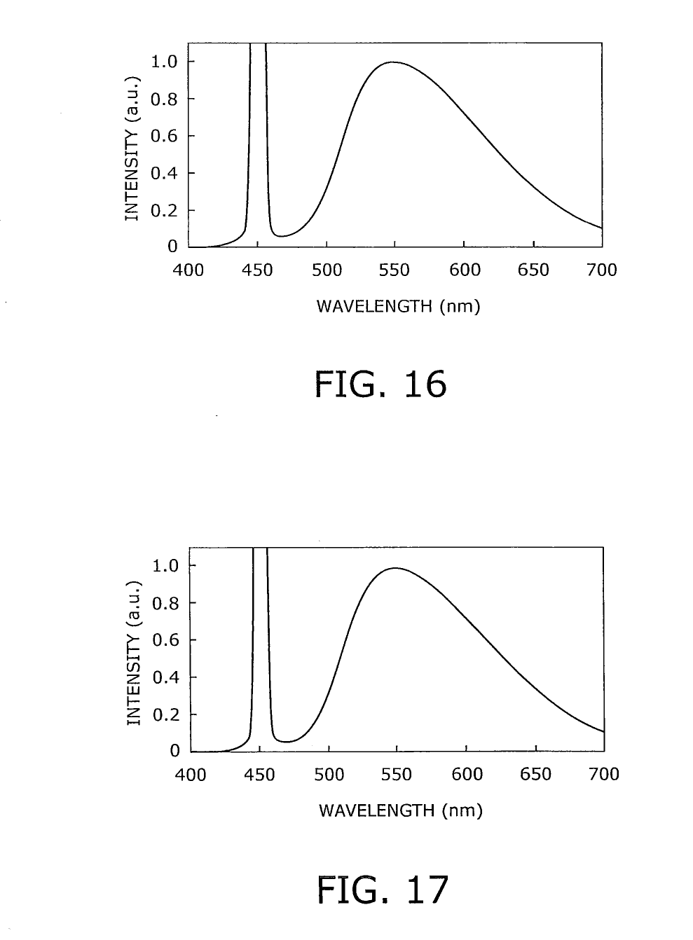

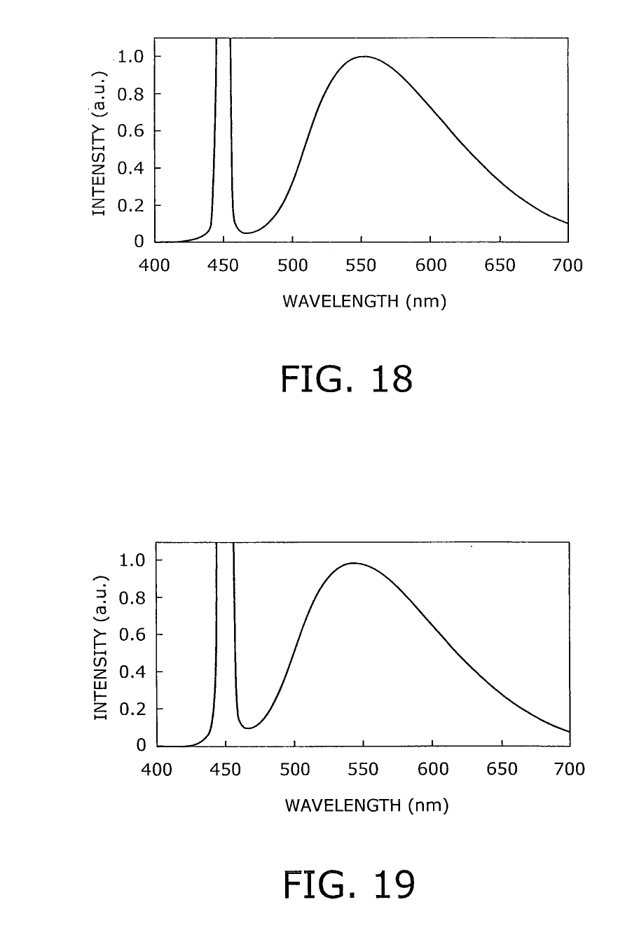

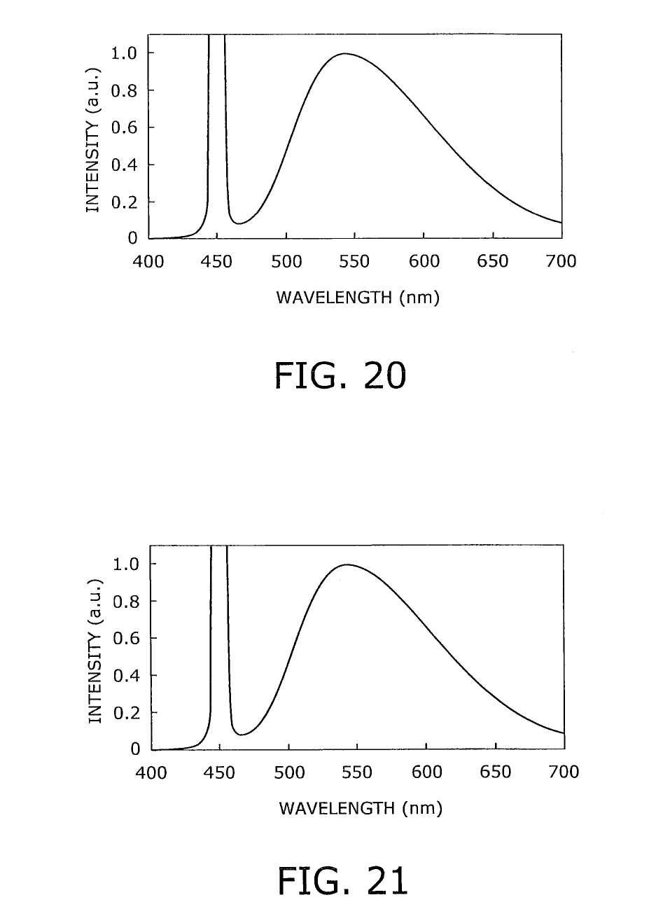

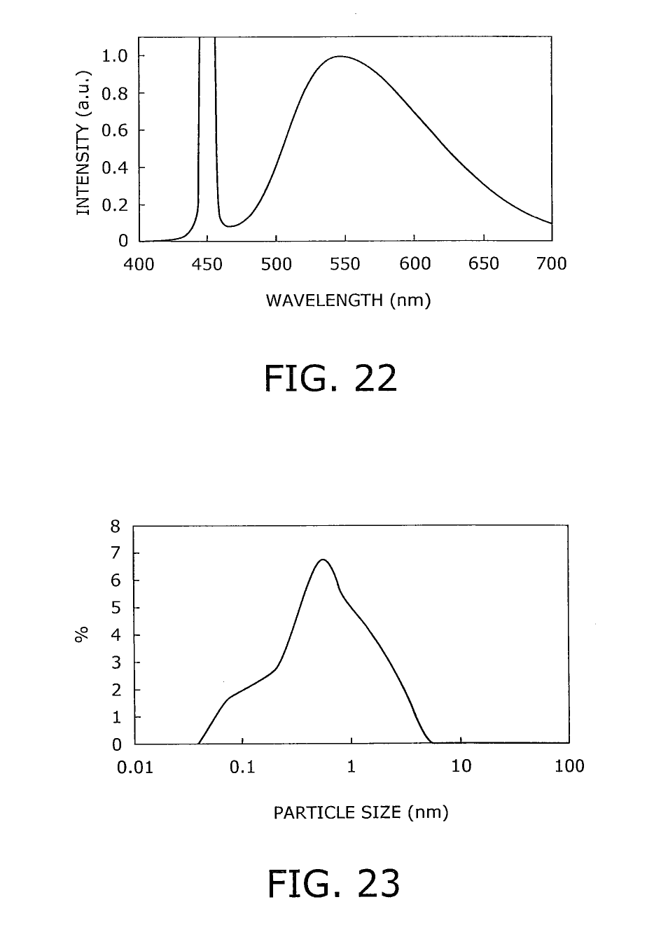

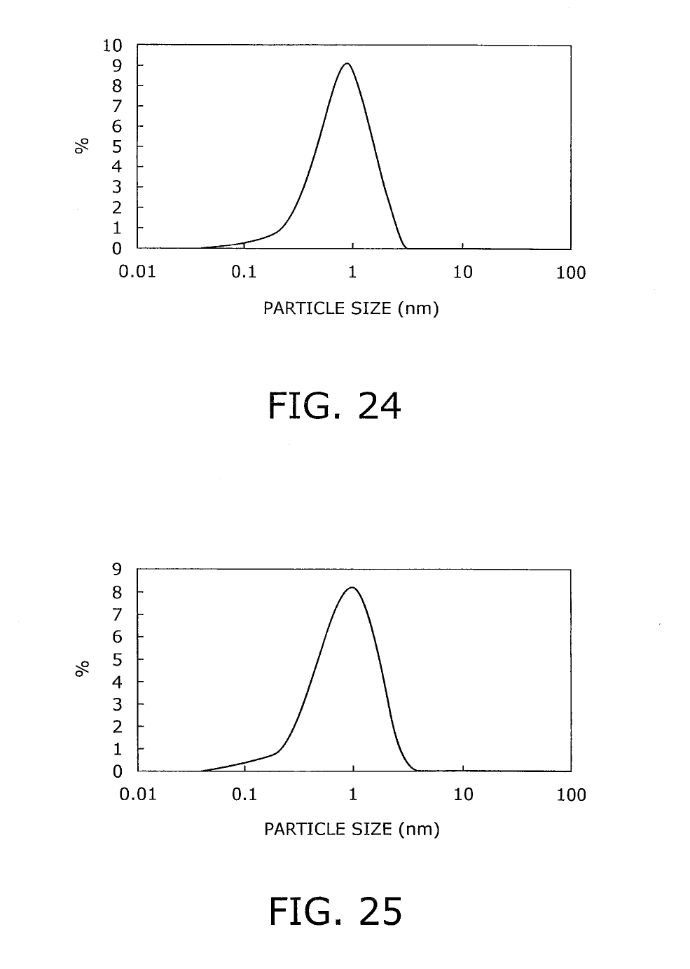

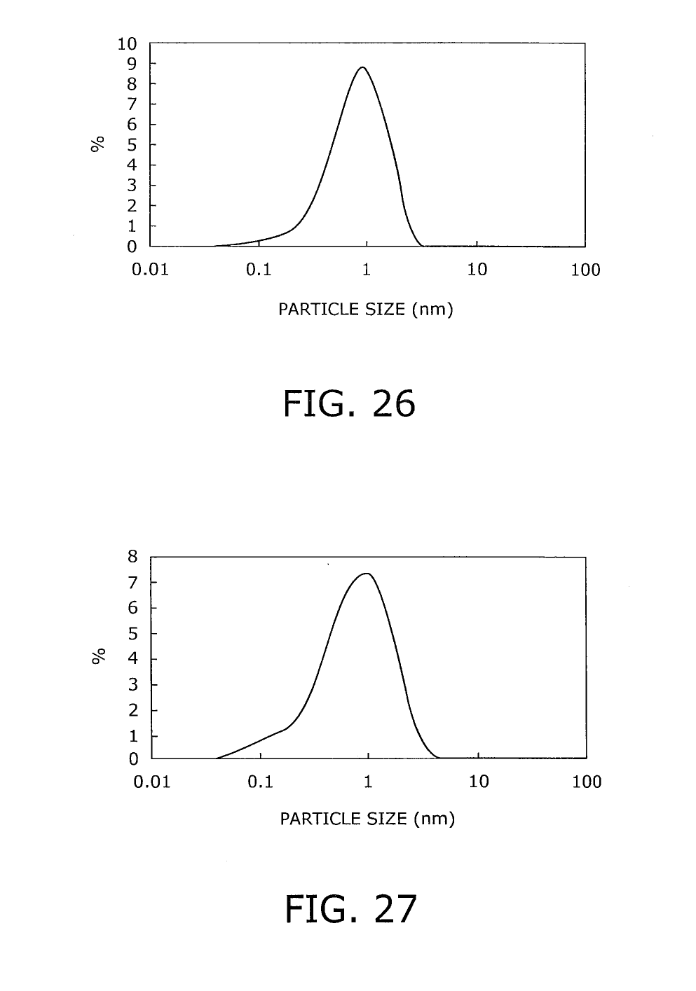

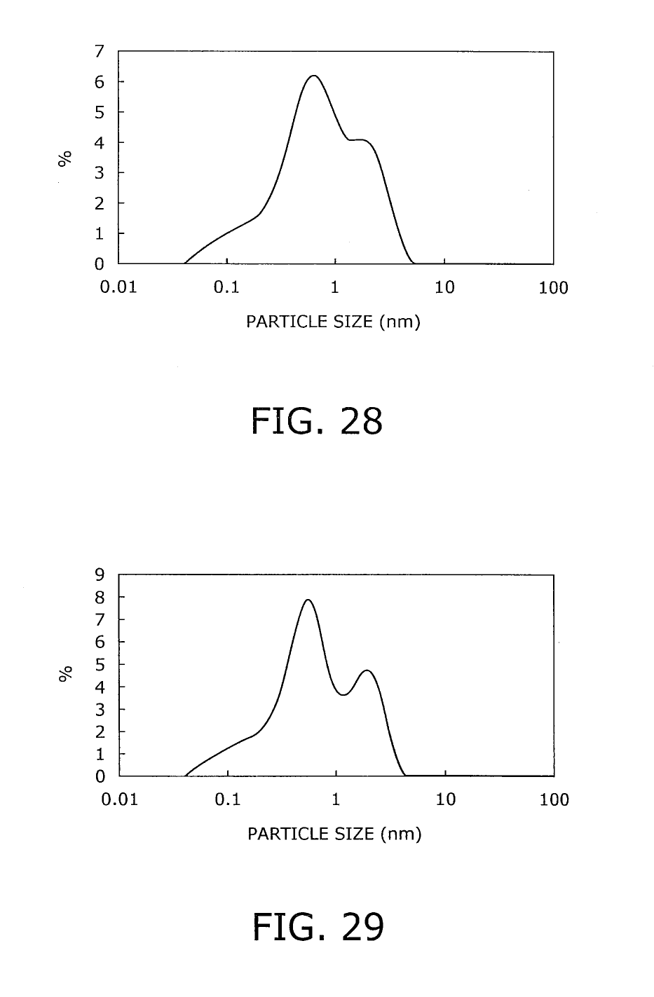

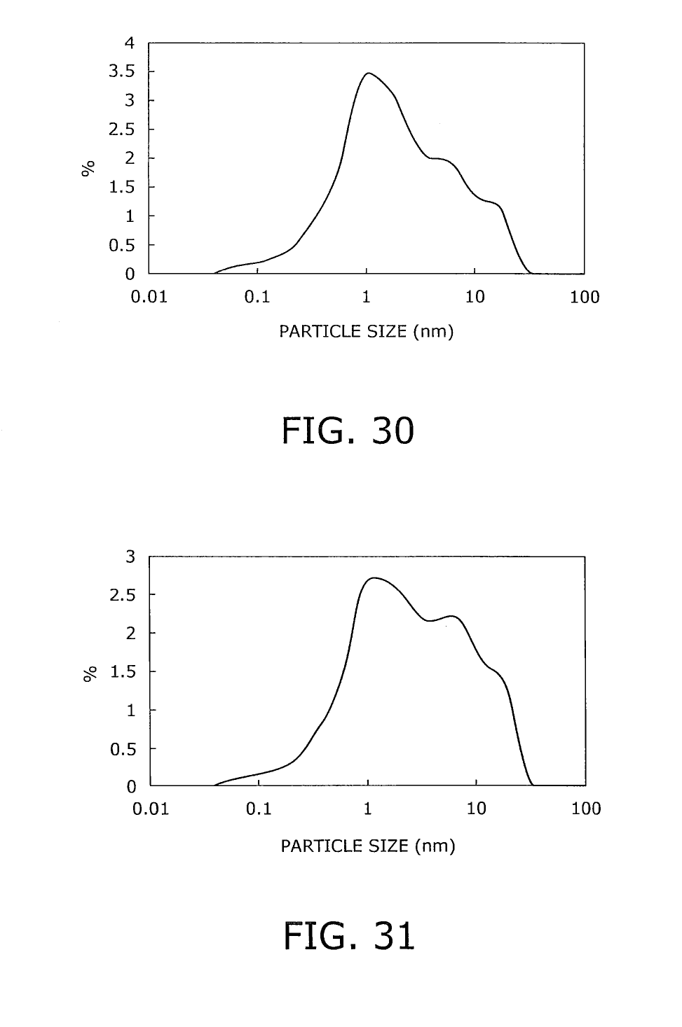

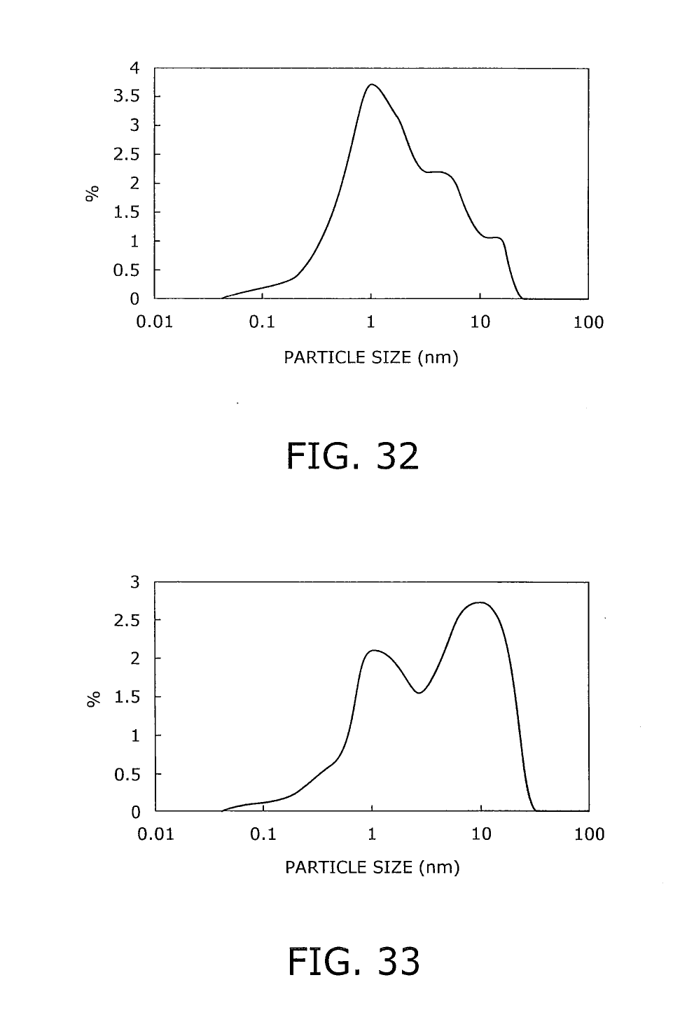

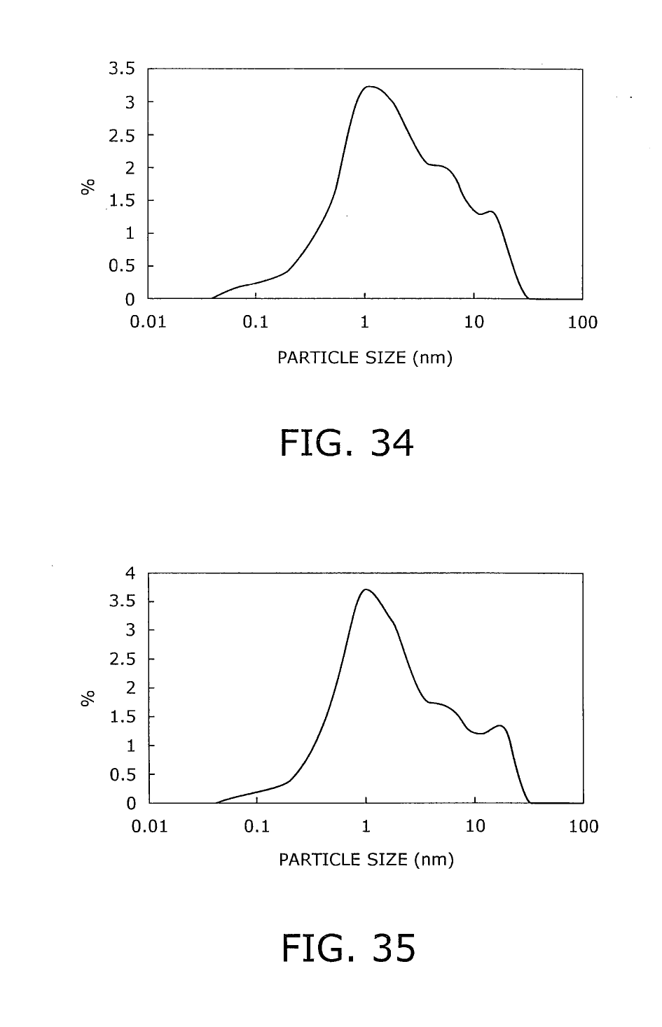

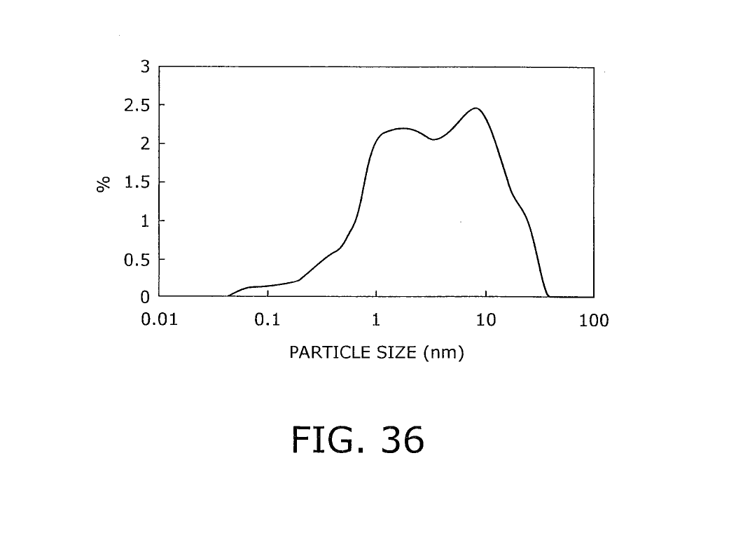

Each fluorescent substance was irradiated with light of 450 nm to measure the emission spectrum and the luminous efficiency. FIGS. 2 to 22 show the emission spectra of Examples and Comparison examples. Further, Table 2 gives the energy difference corresponding to the half-width in each emission spectrum, and also gives the luminous efficiency of each fluorescent substance provided that the efficiency of Comparison example 4 was regarded as a standard. The particle size distribution of the material mixture in each example was shown in FIGS. 23 to 36.

TABLE 2

| | | | | | Half-width | Luminous |
|---|---|---|---|---|---|---|
| | D10 | D50 | D90 | D100 | (ev) | efficiency |
| Ex. 1 | 0.091 | 0.493 | 1.879 | 5.000 | 0.452 | 1.34 |
| Ex. 2 | 0.280 | 0.754 | 1.552 | 3.000 | 0.444 | 1.31 |
| Ex. 3 | 0.258 | 0.747 | 1.589 | 3.600 | 0.440 | 1.32 |
| Ex. 4 | 0.270 | 0.754 | 1.576 | 3.000 | 0.448 | 1.36 |
| Ex. 5 | 0.193 | 0.696 | 1.673 | 4.000 | 0.451 | 1.34 |
| Ex. 6 | 0.137 | 0.628 | 2.245 | 5.000 | 0.456 | 1.33 |
| Ex. 7 | 0.131 | 0.538 | 2.038 | 4.000 | 0.446 | 1.40 |
| Com. Ex. 1 | 0.339 | 1.533 | 9.501 | 30.000 | 0.463 | 1.11 |
| Com. Ex. 2 | 0.421 | 2.111 | 11.844 | 30.000 | 0.461 | 1.15 |
| Com. Ex. 3 | 0.346 | 1.399 | 7.647 | 23.000 | 0.460 | 1.21 |
| Com. Ex. 4 | 0.531 | 3.719 | 14.764 | 36.000 | 0.476 | 1.00 |
| Com. Ex. 5 | 0.335 | 1.611 | 10.007 | 30.000 | 0.472 | 1.08 |
| Com. Ex. 6 | 0.346 | 1.406 | 10.778 | 30.000 | 0.471 | 1.10 |
| Com. Ex. 7 | 0.495 | 2.924 | 14.062 | 30.000 | 0.468 | 1.05 |

From the above results, it was verified that a yellow light-emitting fluorescent substance having higher luminous efficiency can be obtained when materials of (Sr,Ce)₂Si₇Al₃ON₁₃ phosphor are mixed and pulverized according to the embodiment of the present disclosure, as compared to when they are dry-mixed in a conventional manner. The reason why the above favorable luminescent property is obtained is thought to be that, in the embodiment of the present disclosure, the particle sizes of the powdery material mixture are so controlled that the emission centers can be evenly coordinated and hence that components giving variant luminescent properties are hardly formed in the resultant phosphor crystal.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A fluorescent substance represented by the following formula (1):
(M₁₋ₓREₓ)_{2y}Al_{z}Si_{10-z}OᵤN_{w} (1)
in which
M is at least one element selected from the group consisting of Ba, Sr, Ca, Mg, Li, Na and K;
RE is an element selected from the group consisting of Ce, Tb, Eu and Mn; and
x, y, z, u and w are numbers satisfying the conditions of
0<x≦1,
0.8≦y≦1.1,
2.4≦z≦3.5,
0<u≦1,
1.8≦z−u and
13≦u+w≦15, respectively,
wherein said fluorescent substance emitting luminescence with a peak in the wavelength range of 500 to 600 nm under excitation by light in the wavelength range of 250 to 500 nm, and showing an emission spectrum in which the emission band with said peak has a half-width corresponding to an energy difference of 0.457 eV or less.

2. The fluorescent substance according to claim 1, wherein said element RE is Ce.

3. The fluorescent substance according to claim 1, wherein said element M is Sr.

4. A method for producing the fluorescent substance according to claim 1, wherein a material mixture is pulverized so that the particle size distribution thereof may have a D90 value of 5 μm or less and is then fired,
wherein said material mixture contains
an M-containing compound selected from the group consisting of nitride and carbide of M,
a RE-containing compound selected from the group consisting of chloride, oxide, nitride and carbonate of RE,
an Al-containing compound selected from the group consisting of nitride, oxide and carbide of Al, and
a Si-containing compound selected from the group consisting of nitride, oxide and carbide of Si.

5. The method according to claim 4, wherein said material mixture is pulverized with a jet mill.

6. The method according to claim 4, wherein said Si-containing compound is Si₃N₄.

7. A fluorescent substance obtained by:
preparing a material mixture containing
an M-containing compound selected from the group consisting of nitride and carbide of at least one M element selected from the group consisting of Ba, Sr, Ca, Mg, Li, Na and K,
a RE-containing compound selected from the group consisting of chloride, oxide, nitride and carbonate of a RE element selected from the group consisting of Ce, Tb, Eu and Mn,
an Al-containing compound selected from the group consisting of nitride, oxide and carbide of Al, and
a Si-containing compound selected from the group consisting of nitride, oxide and carbide of Si;
pulverizing said material mixture so that the particle size distribution thereof may have a D90 value of 5 μm or less;
and then
firing said material mixture.

8. The fluorescent substance according to claim 7, which is represented by the following formula (1):
(M₁₋ₓREₓ)_{2y}Al_{z}Si_{10-z}OᵤN_{w} (1)
in which
M is at least one element selected from the group consisting of Ba, Sr, Ca, Mg, Li, Na and K;
RE is an element selected from the group consisting of Ce, Tb, Eu and Mn; and
x, y, z, u and w are numbers satisfying the conditions of
0<x≦1,
0.8≦y≦1.1,
2≦z≦3.5,
0<u≦1,
1.8≦z−u and
13≦u+w≦15, respectively,
wherein said fluorescent substance emitting luminescence with a peak in the wavelength range of 500 to 600 nm under excitation by light in the wavelength range of 250 to 500 nm.
